(19) United States
(12) Patent Application Publication
(10) Pub. No.: US 2022/0109782 A1
(43) Pub. Date: Apr. 7, 2022

(54) WORLD-FACING CAMERA ON ELECTRONIC DEVICE

(71) Applicant: Lenovo (Singapore) Pte. Ltd., Singapore (SG)

(72) Inventors: Jonathan Jen-Wei Yu, Raleigh, NC (US); Dhruvi Suresh Fulfagar, Union City, CA (US)

(21) Appl. No.: 17/061,039

(22) Filed: Oct. 1, 2020

(51) Int. Cl. H04N 5/225; G06F 1/16

(52) U.S. Cl. CPC H04N 5/2252; G06F 1/1616; H04N 5/22541

(57) ABSTRACT

One embodiment provides a convertible device, including: a first cover, the first cover comprising a camera system including at least one world-facing camera; and a second cover movable relative to the first cover between at least a first position and a second position, the second cover including a visibility portion defining a pathway for light transmission to the camera system in the second position. Other aspects are described and claimed.

### BACKGROUND

Individuals frequently utilize cameras on their information handling devices (“devices”), for example laptop computers, clamshell-style smart phones, other type of convertible devices, and the like, to capture images and/or videos. For example, a user may utilize a front-facing camera to capture a self-image or, alternatively, may utilize a world-facing camera to capture a world view image.

### BRIEF SUMMARY

In summary, one aspect provides a convertible device, comprising: a first cover, the first cover comprising a camera system including at least one world-facing camera; and a second cover movable relative to the first cover between at least a first position and a second position, the second cover including a visibility portion defining a pathway for light transmission to the camera system in the second position.

Another aspect provides a base portion of a convertible device, comprising: a user input interface located on a top side of the base portion; and a visibility portion, positioned at a different location than the user input interface, defining a pathway for light transmission through the top side and a bottom side of the base portion.

Yet a further aspect provides a foldable electronic device, comprising: a front side, the front side comprising: a camera system including a front-facing camera; and a user input portion; a back side, the back side comprising another camera system including a world-facing camera; and a visibility portion defining a pathway for light transmission, through the foldable electronic device, to the another camera system when the foldable electronic device is situated in a folded orientation

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 (A-B) illustrates a convertible device containing a world-facing camera and a cutout hole according to an embodiment.

FIG. 4 illustrates a convertible device containing a world-facing camera and a cutout portion according to an embodiment.

FIG. 5 (A-B) illustrates a convertible device containing a world-facing camera and an overhang according to an embodiment.

FIG. 6 illustrates a convertible device containing a world-facing camera and an optically clear lens according to an embodiment.

FIG. 7 provides a method for adjusting opacity of an optically clear lens according to an embodiment.

FIG. 8 illustrates a convertible device containing a world-facing camera and a detachable portion according to an embodiment.

FIG. 9 provides a method for dynamically activating and deactivating a world-facing camera according to an embodiment.

FIG. 10 illustrates a foldable device containing a world-facing camera and a visibility portion according to an embodiment.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Conventional convertible laptop devices (“convertible devices”) are generally equipped with only a single front-facing camera. Users may utilize this camera to take self-images and/or videos (colloquially known as “selfies”), participate in video chats with other users, participate in virtual meetings, etc. World-facing cameras, however, are often omitted from convertible devices for a variety of reasons. For instance, the sensor stack for the world-facing camera is expensive to implement into the device (e.g., into the A-cover of the device, etc.). Additionally, as another example, the size of the world-facing camera sensor stack prevents it from neatly fitting into traditional AB cover designs. Furthermore, the lack of world-facing applications in the PC software ecosystem does not drive demand for such a configuration.

Although capable of providing some utility, the front-facing camera sensor configuration severely limits a user's capability of performing a variety of different functions when the device is in tablet or clamshell mode. More particularly, the lack of a world-facing camera on convertible devices prevents users from capturing high quality world facing pictures and/or videos, developing various augmented reality and/or mixed reality applications, performing high-level facial recognition and object detection processes, and other like functions.

The convertible devices that are equipped with a world-facing camera (e.g., on the A-cover or C-cover of the convertible device) have their own issues and restrict usage in certain modes. For example, a camera positioned on the C-cover of a device that is situated in laptop mode may simply face up towards the ceilings, effectively making it useless. Similarly, a single world-facing camera cannot be situated on the A-cover of a conventional convertible device because it's usage in tablet mode would be restricted (i.e., the camera would be blocked by the D-cover).

Accordingly, a convertible device is provided that contains a world-facing sensor stack in the A-cover as well as a visibility portion in the C/D cover. In an embodiment, the visibility portion may be associated with a cutout in the C/D cover (e.g., a cutout hole, a cutout portion, etc.). In another embodiment, the visibility portion may be associated with an optically clear lens on the C/D cover. In yet another embodiment, the visibility portion may be associated with at least a partially detachable portion of the C/D cover. In yet another embodiment, the visibility portion may be associated with a foldable portion of the C/D cover. In yet another embodiment, the visibility portion may be associated with a piece of electrochromic glass. All of the aforementioned visibility portions will be described in greater depth herein and may allow a user to effectively utilize a world-facing camera in all positional usage modes of a convertible device.

The illustrated example embodiments will be best understood by reference to the figures. The following description is intended only by way of example, and simply illustrates certain example embodiments.

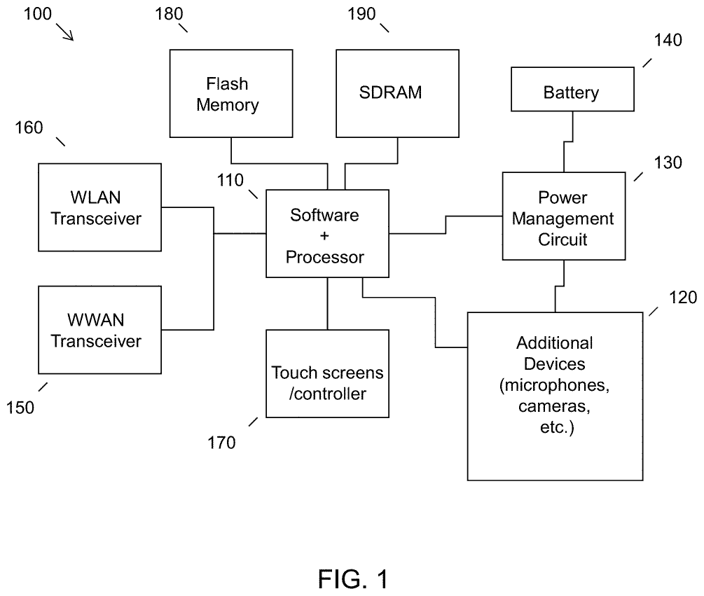

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

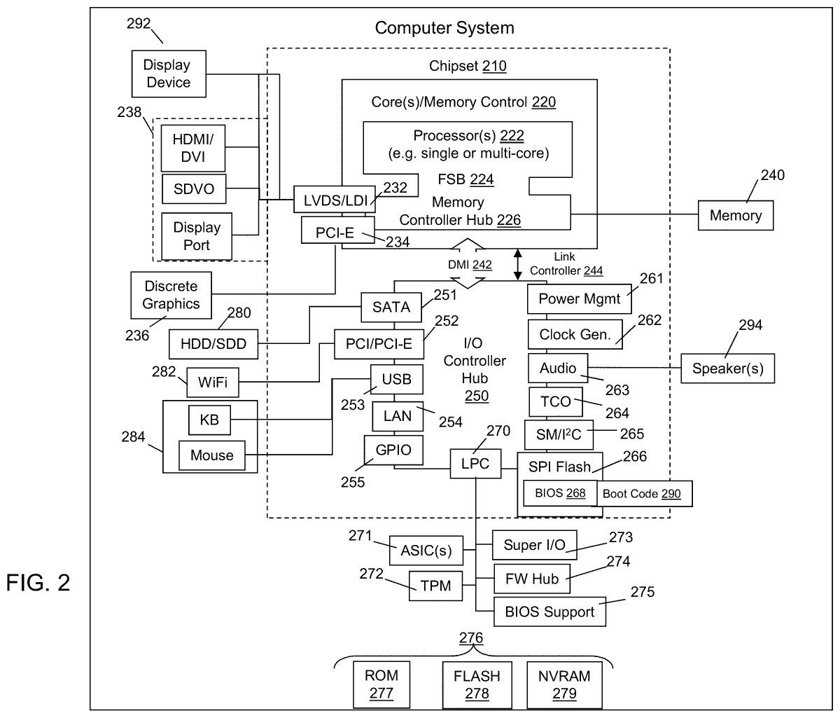

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in convertible devices whose sections may be movable with respect to each other and that have at least one world-facing camera. For example, the circuitry outlined in FIG. 1 may be implemented in a hybrid device embodiment, whereas the circuitry outlined in FIG. 2 may be implemented in a laptop computer.

In the context of this application, it should be understood that a convertible device may be defined as any electronic device that has two covers, i.e., a first cover and a second cover, that are attached together and that may be movable with respect to each other. The first cover may contain, inter alia, a display portion whereas the second cover may contain, inter alia, a user input portion (e.g., physical or virtual keyboard, touch input portion, etc.). Each of these covers has a front and back side that is identified by a conventional cover designation as known in the art (e.g., A-cover, B-cover, C-cover, D-cover, AB-cover, and/or C/D-cover). More particularly, an A-cover may refer to a front side of the first cover, a B-cover may refer to a back side of the first cover (i.e., the side of a clamshell device conventionally containing a display screen), a C-cover may refer to a front side of the second cover (i.e., the side of a clamshell device conventionally containing a user input portion).

Additionally, different types of “visibility portions” are further described herein. These visibility portions provide a way for light to travel through a C/D-cover of a convertible device and reach a sensor stack associated with a worldview camera (e.g., positioned on an A-cover of the convertible device) when the convertible device is adjusted from a clamshell configuration to a tablet configuration (i.e., where the A-cover faces, is parallel to, and/or physically touches the D-cover). Physical and/or dimensional aspects (e.g., size, shape, position, functionality, etc.) of the different types of visibility portions may be configured to accommodate corresponding physical and/or dimensional aspects of the sensor stack associated with the worldview camera.

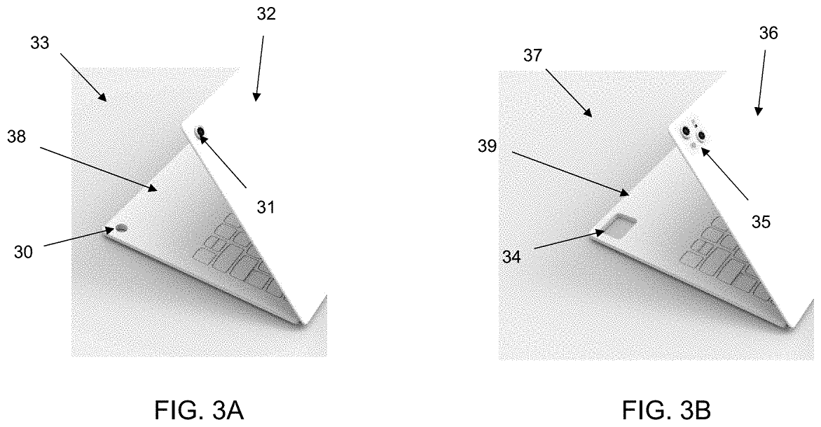

Referring now to FIG. 3 (A-B), illustrations of a convertible device in clamshell mode are provided. In an embodiment, a camera system containing at least one world-facing camera is positioned on the A-cover of each of the devices illustrated in FIG. 3(A-B). Additionally, a cutout hole exists in the C/D-covers of the illustrated devices. In an embodiment, the cutout hole may be shaped to accommodate a footprint of the sensor stack positioned on the A-cover. This accommodation may be achieved by a cutout hole that is larger than the footprint of the sensor stack, a cutout hole that substantially matches a shape of the footprint of the sensor stack, etc.

As a non-limiting example of the foregoing, the cutout hole 30 in FIG. 3A is circular and is shaped to substantially match the single, circular world-facing camera 31 positioned on the A-cover 32 of the convertible device 33. In a similar example, the cutout hole 34 in FIG. 3B is square shaped in order to substantially match the squared footprint of the triple camera system 35 positioned on the A-cover 36 of the convertible device 37. It is also important to note that the location of the cutout holes 30, 34 on the C/D covers 38, 39, as shown in FIG. 3(A-B) respectively, is not limiting. More particularly, the cutout hole may be placed in virtually any location on the C/D cover and the positioning of which may be dependent upon a location on the A-cover where the world-facing camera is positioned.

While in clamshell mode, the presence of the worldview camera on the A-cover allows a user to naturally leverage world-facing camera functionality. Additionally, when the convertible device is rotated into tablet mode, the cutout hole allows users to still leverage the functionality of world-facing camera. More particularly, the cutout hole prevents the C/D-cover of the convertible device from obstructing a field of view of the world-facing camera while in tablet mode.

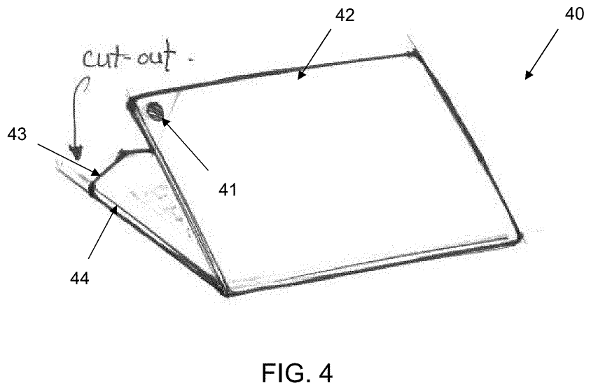

Referring now to FIG. 4, another illustration of a convertible device in clamshell mode is provided. In an embodiment, the world-facing camera 41 of the convertible device 40 is positioned on the A-cover 42 and a cutout portion 43 exists on the C/D-cover 44. The cutout portion 43 may correspond to a portion (e.g., an edge, etc.) of the C/D-cover 44 that is truncated in some way. For example, FIG. 4 illustrates that the cutout portion 43 is a straight cut, however, this is not limiting and the cutout portion 43 may have a different style of cut (e.g., a rounded cut, a squared cut, etc.). Similar to the embodiments described above and illustrated in FIG. 3 (A-B), the cutout portion illustrated in FIG. 4 enables a user to leverage the world-facing camera functionality while the device is utilized in tablet mode. More particularly, the cutout portion 43 enables light to readily reach a sensor stack associated with the world-facing camera 41 because the portion of the C/D-cover that would have blocked the light is removed.

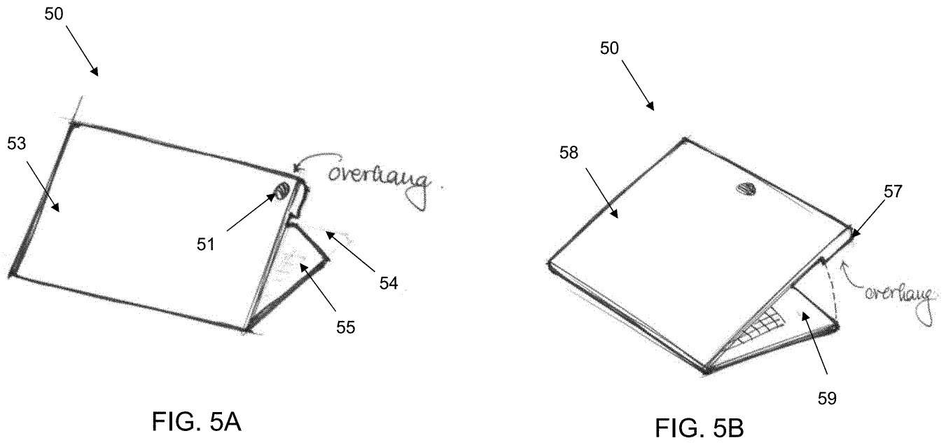

The presence of the cutout hole and/or the cutout portion enables designers to leverage larger optics/lenses in the cutouts. Additionally, camera capabilities can be enhanced with various “inserts”, similar to how a camera can attach different types of lenses such as telephoto, wide angle, macro, etc. More particularly, these inserts can snugly fit into the cutout hole or overhang through the cutout portion when the convertible device is folded closed. Referring now to FIG. 5A, an illustration of a convertible device 50 in clamshell mode is provided in which a protruding world-facing camera sensor stack 51 is positioned on the A-cover 53 and a cutout portion 54 is positioned on the C/D cover 55. As can be seen from the illustration, the protruding world-facing camera sensor stack 51 will not interfere with the C/D cover 55 when the convertible device 50 is folded closed due to the overhang. A similar conceptual embodiment is illustrated in FIG. 5B. More particularly, FIG. 5B illustrates a convertible device 56 in clamshell mode that contains a protruding world-facing camera sensor stack 57 positioned on the A-cover 58 that hangs over a shortened C/D-cover 59 of the convertible device 56.

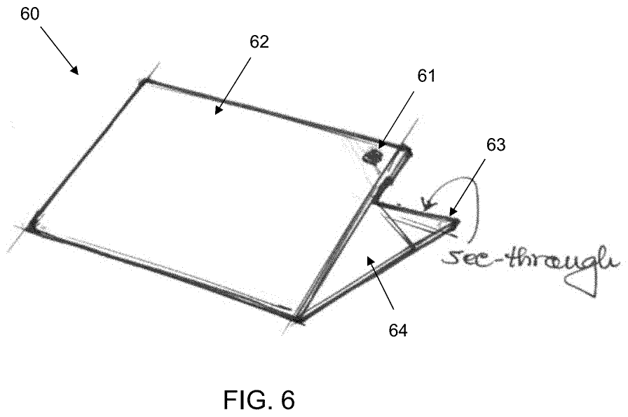

Referring now to FIG. 6, another illustration of a convertible device in clamshell mode is provided. In an embodiment, a world-facing camera 61 of a convertible device 60 is positioned on the A-cover 62 and an optically clear lens 63 exists on the C/D cover 64. The benefits provided by the presence of the optically clear lens 63 are similar to the benefits described above with respect to FIGS. 3-5, i.e., that the optically clear lens 63 in the C/D cover 64 prevents obstruction of a field of view of the world-facing camera 61 in the A-cover while the convertible device 60 is oriented in tablet mode. In an embodiment, the optically clear lens 63 may be shaped to accommodate a footprint of the sensor stack positioned on the A-cover. This accommodation may be achieved by an optically clear lens 63 that is larger than the footprint of the sensor stack (e.g., as illustrated in FIG. 6) or an optically clear lens 63 that substantially matches a shape of the footprint of the sensor stack. Additionally, the optically clear lens 63 may be positioned on the C/D-cover 64 to mirror and/or be parallel to the world-facing camera 61 when the convertible device 60 is oriented in tablet mode (i.e., when the A-cover faces the D-cover).

In an embodiment, the optically clear lens may be electrochromic glass, a.k.a., “smart glass” or “switchable glass”. In this situation, the light transmission properties of the optically clear lens may be altered when voltage, light, or heat is applied to it. More particularly, as a non-limiting example, the optically clear lens may be opaque while the convertible device is oriented in clamshell mode and thereafter adjusted to be translucent when in tablet mode. This adjustment may be facilitated by the method described below.

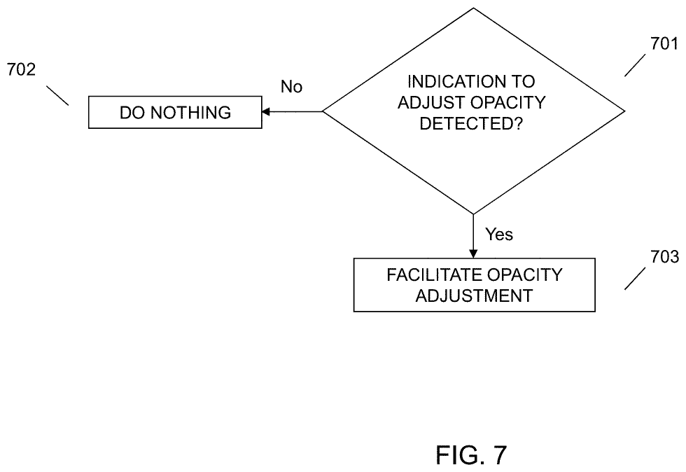

Turning now to FIG. 7, a method is provided for adjusting opacity of an optically clear lens. In an embodiment, the optically clear lens may contain electrochromic properties that enable its opacity to be adjusted (e.g., to be more translucent, to be less translucent, etc.). At 701, an embodiment may first detect an indication to adjust opacity of the optically clear lens. This detection may involve detecting that a predetermined event has occurred. For example, an embodiment may detect that an explicit opacity adjustment input has been received from a user. This opacity adjustment input may be provided by the user via interaction with the system (e.g., by pressing a virtual button on a display screen of the convertible device, by pressing a physical button located on some portion of the convertible device, by interacting with either a virtual or physical opacity adjusting sliding scale, etc.). As another example, this detection may be more dynamic. For instance, one or more sensors (e.g., gyroscopic sensors, camera sensors, etc.) of the convertible device may be able to identify the operating modes that the convertible device is adjusted to or is being adjusted to. The indication may be detected by identifying that the convertible device is situated in, or is being adjusted to, a particular mode (e.g., clamshell mode to tablet mode, vice versa, etc.).

Responsive to not detecting any indication, at 701, to adjust the opacity of the optically clear lens, an embodiment may, at 702, take no additional action. Conversely, responsive to detecting an indication, at 701, to adjust the opacity of the optically clear lens, an embodiment may, at 703, facilitate opacity adjustment. In an embodiment, a voltage controller may be resident within the convertible device that is responsible for transmitting a burst of electricity to the optically clear lens. The electricity burst may be transmitted by the voltage controller in response to receiving a communication from the system that the indication to adjust the opacity of the optically clear lens has been detected. Upon receiving the electric burst, the opacity of the optically clear lens may be adjusted between two stages (e.g., from substantially translucent to substantially opaque, and vice versa). Once the opacity has been adjusted, a continued electric charge is not required. Stated differently, an embodiment may remain in the adjusted state until a subsequent burst of electricity is detected.

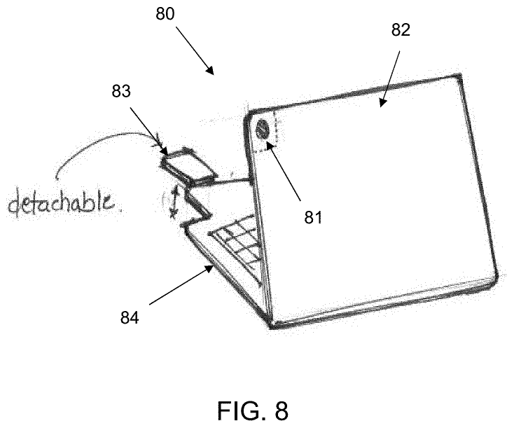

Referring now to FIG. 8, another illustration of a convertible device in clamshell mode is provided. In an embodiment, a world-facing camera 81 of a convertible device 80 is positioned on the A-cover 82 and a detachable portion 83 exists on the C/D-cover 84. The detachable portion 83 may be detached from the convertible device 80 by a user and later reattached to the convertible device 80 by one or more conventional mechanical and/or magnetic means. In an embodiment, the detachable portion 83 may be completely detached and removed from the convertible device 80 (as illustrated in FIG. 8) or, alternatively, may be detached from its native position and folded down back over the C/D-cover 84 of the convertible device 80. In an embodiment, the shape and/or location of the detachable portion 83 is variable and may be shaped and/or positioned to match a shape and/or position of a corresponding world-facing camera sensor stack 81 positioned on the A-cover 82. The benefits provided by the detachable portion are similar to those described in the embodiments above, i.e., removal of the detachable portion when the device is operating in tablet mode may prevent obstruction of the field of view of the world-facing camera 81 by the C/D cover 84.

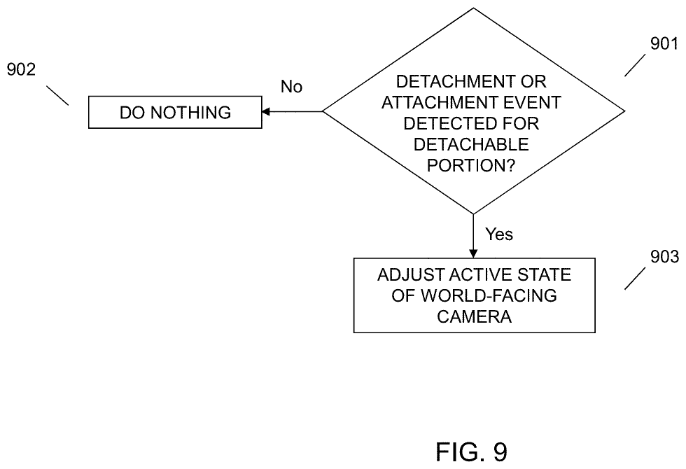

In an embodiment, the attachment and/or detachment of the detachable portion may provide an indication to the system to perform a predetermined function with respect to the world-facing camera. For example, referring now to FIG. 9, an embodiment provides a method for dynamically activating and deactivating a world-facing camera. At 901, an embodiment may detect whether a detachable portion has been attached or detached to the convertible device. This detection may be facilitated by one or more sensors (e.g., proximity sensors, camera sensors, etc.) of the convertible device. Responsive to not detecting, at 901, a change in the positioning and/or presence of the detachable portion, an embodiment may, at 902, take no additional action. Conversely, responsive to detecting, at 901, a change in the positioning and/or presence of the detachable portion, an embodiment may, at 903, activate or de-activate the world-facing camera of the convertible device. For example, responsive to detecting that the detachable portion of the device has been detached, an embodiment may correspondingly activate the world-facing camera in anticipation of its use. In the opposite, responsive to detecting that the detachable portion of the device has been re-attached, an embodiment may correspondingly de-activate the world-facing camera.

Although the embodiments listed above were described with reference to a convertible device (i.e., a device consisting of two primary sections or parts, e.g., a base section and a display section), such a designation is not limiting. More particularly, the concepts described throughout this application may also be implemented on a single-bodied device (e.g., a smart phone or tablet, etc.). Such a device may be a foldable device having a touch-sensitive display screen that may fold over itself (e.g., horizontally in half, vertically in half, etc.).

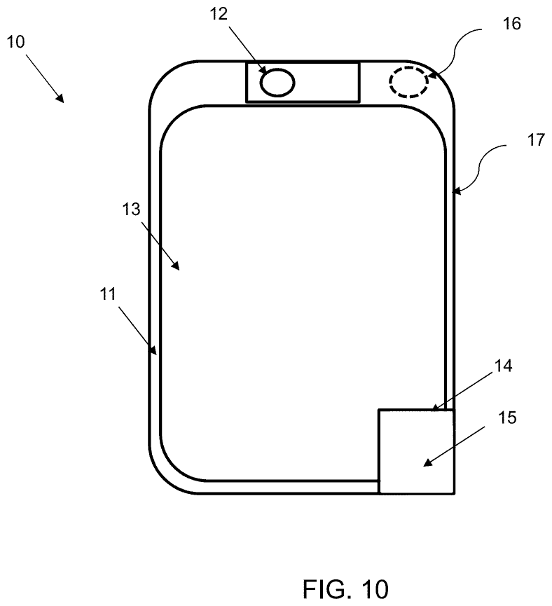

Referring now to FIG. 10, a foldable device as mentioned above is illustrated. The foldable device 10 may contains a front cover 11 that includes a front-facing camera 12 as well as a touch sensitive-display 13. In an embodiment, the touch-sensitive display 13 may occupy a portion of the front cover 11, or alternatively, may be an edge-to-edge display and occupy substantially all of the front cover 11. In the illustration, the touch-sensitive display 13 contains a notch 14 in which a visibility portion 15, of the variety described above, exists. This visibility portion 15 allows a sensor stack associated with a world-facing camera 16 positioned on a back cover 17 of the foldable device 10 to receive light when the foldable device 10 is situated in a folded orientation (e.g., when the foldable device is horizontally folded so that the visibility portion may be parallel, or adjacent to, the world-view camera).

The various embodiments described herein thus represent a technical improvement to conventional world-facing camera configurations on various types of electronic devices (e.g., convertible devices, foldable devices, etc.). Using the embodiments described herein, users can effectively utilize a world-facing camera on a convertible device in laptop mode or tablet mode. Additionally, the embodiments described herein further negate the need to add two or more world-facing cameras onto multiple covers in order to allow a user to leverage world-facing camera functionality between modes.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A convertible device, comprising:
a first cover, the first cover comprising a camera system including at least one world-facing camera, wherein the world-facing camera is positioned on the outside surface of the convertible device in a clamshell mode; and
a second cover movable relative to the first cover between at least a first position and a second position, the second cover including a visibility portion defining a pathway for light transmission to the camera system in the second position, wherein the world-facing camera and the visibility portion align in a tablet mode.

2. The convertible device of claim 1, wherein the first position corresponds to a clamshell orientation of the convertible device and wherein the second position corresponds to a tablet orientation of the convertible device.

3. The convertible device of claim 2, wherein a location of the visibility portion on the second cover is associated with a position of the world-facing camera on the first cover when the convertible device is adjusted to the second position.

4. The convertible device of claim 1, wherein a shape of the visibility portion substantially accommodates a corresponding shape of a footprint of the world-facing camera.

5. The convertible device of claim 1, wherein the visibility portion is defined by a cutout hole in the second cover.

6. The convertible device of claim 1, wherein the visibility portion is defined by a cutout portion.

7. The convertible device of claim 6, wherein the cutout portion is one of: a straight cut, a squared cut, and a rounded cut.

8. The convertible device of claim 6, wherein the world-facing camera comprises an attachment and wherein the attachment overhangs from the first cover when the convertible device is in the second position.

9. The convertible device of claim 1, wherein the visibility portion is defined by an optically clear lens.

10. The convertible device of claim 9, wherein the optically clear lens is electrochromic glass, the electrochromic glass having an opacity that is adjustable in response to an electric charge.

11. The convertible device of claim 10, further comprising;
a processor;
a memory device that stores instructions executable by the processor to transmit the electric charge to the electrochromic glass in response to detection of a transition of the convertible device between the first position and the second position.

12. The convertible device of claim 1, wherein the visibility portion is defined by a completely detachable portion of the second cover to permit the light transmission to the camera system in the second position.

13. The convertible device of claim 12, further comprising:
a processor;
a memory device that stores instructions executable by the processor to:
detect an interaction event with the detachable portion; and
transmit an indication to the camera system to adjust an active state of the at least one world-facing camera responsive to the detection of the interaction event.

14. The convertible device of claim 1, wherein the visibility portion is defined by a partially detachable portion of the second cover to permit the light transmission to the camera system in the second position.

15. The convertible device of claim 14, wherein the second cover comprises a top portion and a bottom portion and wherein the partially detachable portion is foldable behind the bottom portion.

16. A base portion of a convertible device, comprising:
a user input interface located on a top side of the base portion, the base portion attachable to a display portion comprising a world facing camera in which the world-facing camera is positioned on the outside surface of the convertible device in a clamshell mode; and
a visibility portion, positioned at a different location than the user input interface, defining a pathway for light transmission through the top side and a bottom side of the base portion, wherein the world-facing camera and the visibility portion align in a tablet mode.

17. The base portion of claim 16, wherein the base portion is attachable to a display portion of the convertible device and wherein the base portion is movable relative to the display portion between at least a first position and a second position.

18. The base portion of claim 17, wherein a dimensional characteristic of the visibility portion is dependent upon a dimensional characteristic of a footprint of a camera system resident on the display portion.

19. The base portion of claim 16, wherein the visibility portion is of a type selected from the group consisting of: a cutout, an optically clear lens, and a detachable portion.

20. A foldable electronic device, comprising:
a front side, the front side comprising:
a camera system including a front-facing camera; and
a user input portion;
a back side, the back side comprising another camera system including a world-facing camera, wherein the world-facing camera is positioned on the outside surface of the convertible device in a clamshell mode; and
a visibility portion defining a pathway for light transmission, through the foldable electronic device, to the another camera system when the foldable electronic device is situated in a folded orientation, wherein the world-facing camera and the visibility portion align in a tablet mode.
